(19) United States
(12) Patent Application Publication
(10) Pub. No.: US 2002/0067674 A1
(43) Pub. Date: Jun. 6, 2002

(54) Method and system for authenticating an optical disc using purposefully provided data errors

(75) Inventors: Karl Schneck, Milford, PA (US); James Weldon, Plano, TX (US); Jerry R. Smith, Littleton, CO (US)

Correspondence Address: SHERIDAN ROSS PC, 1560 BROADWAY, SUITE 1200, DENVER, CO, 80202

(73) Assignee: Hide & Seek Technologies, Inc., Jenks, OK

(21) Appl. No.: 10/057,054

(22) Filed: Jan. 25, 2002

Related U.S. Application Data
(60) Provisional application No. 60/264,372, filed on Jan. 25, 2001.
(60) Provisional application No. 60/040,724, filed on Mar. 14, 1997.

(30) Foreign Application Priority Data
Jun. 5, 1997 (US) PCT/US97/08842

(51) Int. Cl. G11B 7/00

(52) U.S. Cl. 369/53.22

(57) ABSTRACT

Methods for manufacturing optical discs with purposefully provided errors therein are disclosed, wherein the error instances can be used to identify the authenticity of the optical disc. Additionally, methods for determining the authenticity of an optical disc are disclosed, wherein values derived from descriptors of errors found on the disc are compared with corresponding known values indicative of an authentic disc for determining whether the disc was legitimately manufactured or not. Such methods may utilize errors that are correctable, uncorrectable, trackable, and/or untrackable. An end user (or the end user's optical reading laser) may be instructed to purposefully alter a portion of the disc in a predetermined manner so that an unauthorized copy of the disc is easily discoverable by, e.g., activation of an authentication program on the disc or accessible via a network such as the Internet. Embodiments of the present invention may be used to manufacture optical discs with predetermined limits on the accessibility of the data thereon.

### RELATED APPLICATIONS

The present patent application claims: (a) the benefit of U.S. Provisional Patent Application No. 60/264,372 filed Jan. 25, 2001 (pending), and (b) priority from pending U.S. patent application Ser. No. 09/646,141, filed Sep. 13, 2000 (pending), which is the U.S. national filing of International Patent Application No. PCT/US97/08842 filed Jun. 5, 1997 (U.S. national stage entered), which was published in English, which in turn claims priority of U.S. Provisional Serial No. 60/040,724, filed Mar. 14, 1997 (expired). The entire disclosure of the prior applications is considered to be part of the disclosure of the present application and are hereby fully incorporated by reference.

### RELATED FIELD OF THE INVENTION

The present invention is related to a method and system for preventing the unauthorized duplication of an optical disc, and in particular, for using purposefully induced errors on such a disc to determine whether the disc is legitimately manufactured or an illegitimate copy. Accordingly the present invention determines whether information on the disc is to be accessible or not.

### BACKGROUND

The misappropriation of software is rampant irrespective of whether the data storage medium is magnetic or optical. Both magnetic and optical storage discs are particularly susceptible to piracy due to the ease in which illegitimate copies can be made.

The computer industry has long been plagued by the illegal misappropriation of software products. The Software Publisher's Association (SPA), an organization with devotes significant resources to tracking and analyzing piracy problems, has determined that in 1994 alone the personal computer software industry lost in excess of $8 billion due to illegal copying of business application software. The SPA further estimated that virtually half of the business software in use in 1994 was pirated, and this estimate does not include the illegal copying of operating systems, education, entertainment or personal productivity software. The piracy problem is particularly acute in more developed markets such as the United States.

Accordingly, it is desirable to have additional techniques for preventing unauthorized access to data provided on store media such as optical discs.

### SUMMARY OF THE INVENTION

The present invention is a method and system for the protection of optical disc data against copying and/or unauthorized use. In particular, the present invention contemplates purposefully inducing a physical alteration of one or more portions of an optical disc surface during the manufacturing process, within the data area, for the purpose of creating either a correctable or uncorrectable defect within the data stream of an attempted read of one of the physically altered portions of the optical disc. In particular, such read attempts may be performed in response to a query by a software module, either provided on an optical disc manufactured according to the present invention, or external thereto, wherein the module is used for verifying the authenticity of the optical disc. Moreover, in verifying the authenticity of an optical disc, in at least some embodiments, the present invention does not require the changing of any specific bit, rather, it utilizes the data area of the optical disc as a canvas on which to a paint or distribute defects, subject to the requirement that such defects reside within some specific area of the optical disc. The physical alteration of the optical disc surface for providing the defects can be accomplished by first providing corresponding defects within an optical disk master from which the optical disk may be manufactured. Alternatively, the defects in the optical disc may be manufactured into the optical disc after the optical disc has had data from the master disc transferred to it.

The disclosure herein provides additional inventive aspects related to U.S. patent application Ser. No. 09/646,141, filed Sep. 13, 2000, which is fully incorporated herein by reference.

Other features and aspects of the present invention will become evident from the detailed description and the accompanying figures herewith.

### BRIEF DESCRIPTION OF THE DRAWINGS

FIG. 1 illustrates an enlarged view of a data portion on an optical disk with pits 2010 aligned in rows or tracks extending radially outwardly in the direction 24 from a point about which the optical disk is intended to rotate when data is written or read. Further, this figure shows pit 2020 of extended length in the tracking direction 2028, wherein this extended pit is intentionally generated during the manufacturing of the optical disk and where this pit is detected as a defect in the optical disk.

FIG. 2 is identical to FIG. 1 except that the extended pit 2020 is replaced by an extended land 2022.

FIG. 3 is similar to FIGS. 1 and 2, except that the intentionally manufactured defect 2026 spans multiple rows or tracks on the optical disk;

FIG. 4 is a high level flowchart illustrating the purposeful insertion of errors in the process for manufacturing optical discs so that errors are provided on the resulting optical discs in a manner that these errors can be used to determine the authenticity of the discs; and

FIG. 5 is a high level flowchart of the steps performed when a user attempts to access the information in an optical disc manufactured according to the present invention.

### DETAILED DESCRIPTION

Regarding the aspect of the present invention related to the manufacturing of defects into an optical disc, the following techniques 1 through 4 hereinbelow are within the scope of the present invention.

1. A defect in a master disc (a mastered defect) may be created by: (a) generating a continuous data land or data pit of sufficient length in the tracking direction; or (b) generating a series of defective data lands and/or data pits of sufficient frequency and/or length and/or data encoding peculiarity in the tracking direction to induce either a correctable or uncorrectable data error when the defect is transferred to an optical disc and an attempt to read the optical disc is performed by an optical disc reader. To generate such mastered defects, note that the process of mastering involves the conversion of a digital or analog source signal to code for subsequent translation into a digital pattern of pits and lands, wherein the transitions between lands and pits of the master disc are intended to then translate into readable data on an optical disc generated from the master disc. Accordingly, in one embodiment, the software for the present invention is intended to be incorporated into the software for controlling a master disc generating device. In particular, this software modifies the code derived from the source signals by replacing portions thereof with code interleaved with one or more encodings of purposefully induced defects. In some embodiments, the appropriate information (e.g., programs and/or data) to decode a specified encoded pattern of purposefully induced defects is incorporated into the original program content.

The placement of the defects is controlled such that the created errors are individually detectable. One method of performing this may be the placement of defects in no more than every third sector, so that the effect of the normal interleaving of the original data is negated such that a detected error in a specific block of three sectors can be identified as being the effect of a purposefully induced defect in a specific sector.

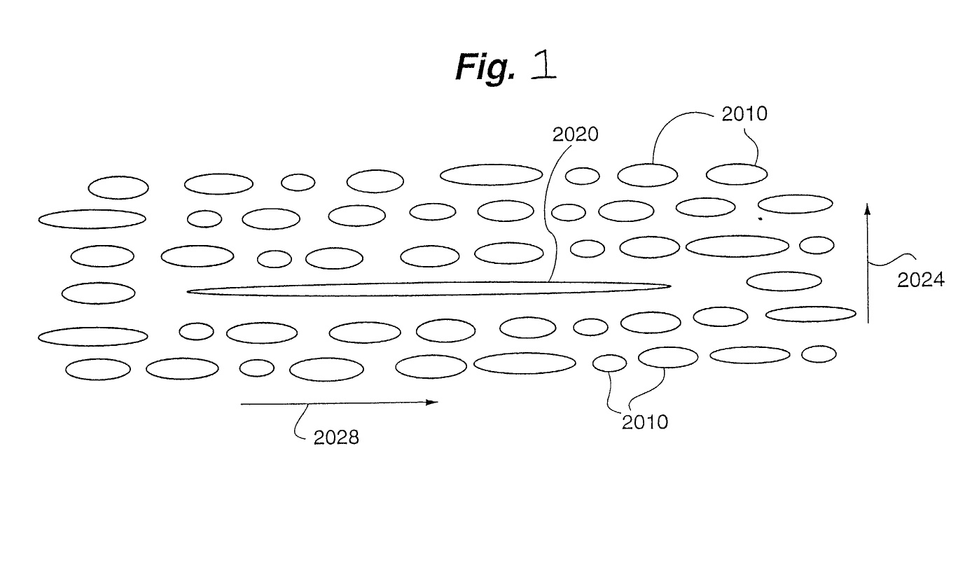

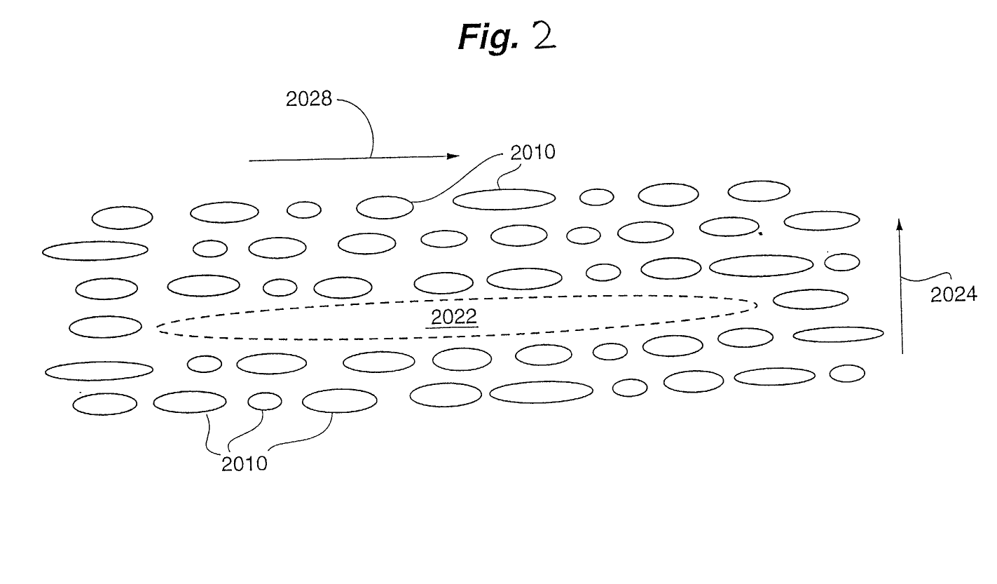

Further, this software may determine the areas of a master disc in which to place each purposefully induced defect by its sector address or time code. Subsequently, the software of the present invention causes the master disc generating device to use the modified code in place of the code derived directly from the source signals to thereby generate defects on a master disc. For example, the defective code may be a continuous data pattern of 1s or a continuous pattern of 0's, which, in turn causes an LBR (Laser Beam Recorder) of a master disc generating device to either remain in an “on” condition, creating a continuous pit, or to remain “off”, creating a continuous land, as one skilled in the art will understand. Accordingly, by replacing a valid data pattern within an area of the master disc with a continuous data pit 2020 (FIG. 1) or data land 2022 (FIG. 2), a corresponding digital error can be generated on an optical disc generated from the disc master, wherein the error is either correctable or uncorrectable, depending on the size of the defect and its position with regard to surrounding data bits. For example, an uncorrectable such continuous data pit or data land may be at least approximately 300 μm in length, and a correctable such data pit or data land may be less than approximately 300 μm in length. Such a defect 2020 or 2022 may be of normal track width in the radial direction 2024 for the optical disc medium. Note that in a typical optical disc manufacturing process, commercially distributable optical discs have their data encodings created through a variety of manufacturing processes including: injection/compression molding, utilizing a metal stamper which is a generated metal part that is the “inverse image” of the original master disc, or in some cases, the original master disc, where the original master disc is inscribed with the inverse image of the final disc data pattern; and a printing method that creates the data pattern on a subsurface of the final disc.

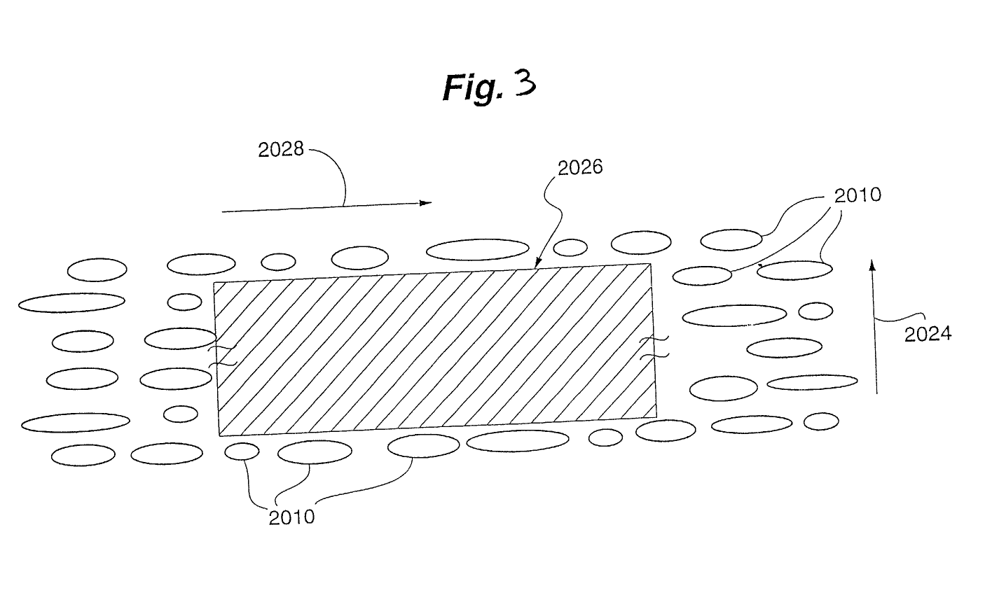

2. Alternatively, a mastered defect may be created that spans multiple tracks. In FIG. 3, a mastered defect 2026 is shown that is of multi-track width in the radial direction 2024. The defect 2026 may be of sufficient length in the tracking direction 2028, or include a long enough series of smaller mastered defects that are of multi-track width in the radial direction 2024 so that either a correctable or uncorrectable data error is generated when a read is attempted.

Accordingly, such a defect 2026 can replace the legitimate data that would normally reside in that particular area.

3. In another embodiment, a mastered defect may be etched into either a glass master or one of the series of metal parts generated from it. Accordingly, the etched defect will be duplicated in the commercially distributable optical discs that are either directly or indirectly generated from the master so that the commercially distributable optical disks have corresponding defects of sufficient length in the tracking direction or there are a series of etched defects of sufficient quantity and length in the tracking direction to cause either a correctable or uncorrectable data error to be generated when such a generated commercially distributable disk is supplied to an optical reader. The process of etching in defects may be accomplished by any means that is adequate to create the desired defect (for example: laser etching, burning, drilling, cutting, slicing, punching, etc.). Such a defect replaces the data that normally resides in the area etched. The defect can be either of normal track width or of multi-track width in the radial direction 2024 for that particular optical disc medium. Such etching may also be controlled by a locating technique which provides a similar data location accuracy as provided by the software program described hereinabove for placing defective data pits or data lands on a master disc. This locating technique may involve: (a) inscribing a radial line outwardly from a center of the surface of the disc; (b) utilizing a testing device to locate both this radial line and the location of a specific data area with respect to the radial line; and (c) having the testing device provide the position of the specific data area with respect to the radial line, wherein the defect will be created on this specific area.

4. In another embodiment, one or more defects can be created in each commercially distributable optical disc by physically damaging each such optical disk directly during the manufacturing process by techniques such as cutting, slicing, punching, burning, etching, painting, sticking the disk with a sharp pointed implement, etc., so that a purposefully induced defect of sufficient length in the tracking direction is produced, or a series of physical defects of sufficient quantity and length in the tracking direction is produced to generate one or more correctable or uncorrectable data errors when a read of the defective area is attempted. As in previous embodiments, the defects for the present embodiment replace the data that would normally reside in the particular areas having the defects. Moreover, such one or more defects are either of normal track width or of multi-track width in the radial direction for the particular optical disc medium being utilized.

Note that in each of the above techniques for purposely creating defects (errors) in an optical disc, the purposely induced errors may be trackable or non-trackable, wherein the term “trackable” is intended herein to mean that an optical disc reader is able to maintain tracking of an optical medium (e.g., an optical disc), and the term “non-trackable” refers to errors that cause the optical disc reader to lose its ability to track through an instance of an untrackable error. The correctable purposely created errors discussed hereinabove are both correctable and trackable. That is, such correctable errors have invalid (but correctable) data encodings therein such that the optical disc reader is able to read, error correct, and track through the invalid data so that uncorrupted data can be read that is adjacent to the invalid data and is, e.g., on the same track(s). However, for the uncorrectable errors discussed hereinabove, these errors may be either trackable or non-trackable. Accordingly, an uncorrectable trackable error is one wherein the optical disc reader functions substantially as in the correctable case described above except that the purposely invalidated data cannot be error corrected to recreate the original data that was purposely changed. Alternatively, for uncorrectable errors that are non-trackable, data adjacent to such an error on the optical disc is not able to be sequentially accessed from the non-trackable error portion of the disc.

In one method of the present invention for purposely creating instances of trackable errors, at least some error instances are such that they are each created between two predetermined readable non-error disc locations. Accordingly, since the optical disc reader corrects such errors, a copy of the disc will not have these error instances therein. Thus, if such trackable errors are used to encode an identifier onto the optical disc, then an illicit copy of the disc will not have the identifier encoded therein. Moreover, the encodings used may include one or more of (or an encrypted version thereof): (a) an identification number (e.g., serial number) unique to one or more optical discs, (b) a product identifier identifying the product(s) encoded the optical disc, (c) a company identifier, (d) a date, and/or (e) other information useful in authenticating the optical disc. Moreover, such information may also be used in tracing the optical disc from its manufacturing source and through its primary distribution sources.

Accordingly, a program (e.g., provided on the optical disc) may attempt to identify such purposefully created trackable errors by deriving an identifier encoded by the trackable errors, and compare the derived identifier with authentication data provided elsewhere on the optical disc or alternatively input by a user. Moreover, such a program may derive the identifier from the trackable error instances and perform the comparison using the following steps once the optical disc is inserted into the optical reader:

Step (A): For each of a plurality of data partitions (e.g., each partition being one or more sectors on the optical disc) of a predetermined portion of the disc: scan the partition read errors, and log a descriptor (denoted an “error descriptor” herein) having information indicative of any (or each) error (e.g., error free, correctable error(s), trackable error(s), or untrackable error(s)) encountered in the partition.

Step (B): For each error descriptor, resulting from Step (A), assign a predetermined corresponding value (denoted herein a “descriptor value”) indicative of whether the error descriptor: is error free, has an error, and optionally, the type of error (e.g., correctable, trackable, untrackable), thereby obtaining a resulting sequence of such descriptor values.

Step (C): Optionally, perform Steps (A) and (B) for one or more additional predetermined portions of the optical disc, thereby obtaining one or more additional sequences of descriptor values. Subsequently, assuming each of the predetermined portions for an authentic optical disc has ideally an identical sequence of descriptor values, compare these initial sequences for deriving a final sequence. In particular, for each error descriptor position p=1, 2, . . . , N, in each of the initial sequences, use the collection of corresponding descriptor values at the position p (one per initial sequence) to determine a most likely final descriptor value for position p.

Step (D): Compare the resulting sequence obtained from Step (B) (optionally, the final sequence from Step (C)) with a predetermined sequence of values indicative of an authentic optical disc (such a predetermined sequence may, e.g., reside on the optical disc or may be obtained via a network communication such as occurs on the Internet). If the comparison yields a sufficiently close (e.g., exact) match, then the optical disc is deemed authentic.

Note that each of the partitions referenced in the steps above may be a collection of three (consecutive or otherwise) sectors on the optical disc. Moreover, in one embodiment, in Step (C) at least two additional predetermined portions of the optical disc are scanned for errors. Accordingly, Step (C) may determine each most likely final descriptor value (i.e., for reach position p) as the descriptor value that occurs most frequently. Thus, if each descriptor value is binary (i.e., indicating “error” or “no error”), then no more than two additional predetermined portions of the optical disc need be scanned to disambiguate each final descriptor value at each position p.

In another method of the present invention for purposely creating instances of non-trackable errors, each such instance may be created so that the instance is detected by the optical disc reader as an unrecorded area. That is, the optical disc reader may view the area of a non-trackable error instance in the same way it views a normally unrecorded area of the disc and/or an area where no optical medium is present. For example, an obstruction may be placed at some location on the optical disc (i.e., on the surface and/or on a sub-surface layer such as a mid-polycarbonate layer) such that the optical disc reader can not read data from the location. Thus, the non-error data for that location may be replaced with non-valid data or no data prior to the data stream (for optical recording) being encoded onto a master disc, or, after the data is recorded onto the master disc, some of the data may be erased. Accordingly, the optical disc reader is unable to copy the data in such an area, and an illicit copy of the optical disc will not have such non-trackable error instances.

In one implementation for providing non-trackable error instances, the present invention provides these instances as one or more non-trackable rings, concentric about the center (or center of rotation) of the optical disc. Moreover, by having these non-trackable rings coincide with the area on the optical disc where data for a predetermined file should be located, any illicit copy of the file onto another optical disc will not have the non-trackable rings, and, in some circumstances, no copy of the file maybe produced. Additionally, since a program for determining certain characteristics of such a file may also be encoded on the optical disc, this program may be used to determine the authenticity of the optical disc. In particular, the program may determine if the file exists, and if so what portions of the file can be read and/or what data is associated with particular offsets within the file. Additionally, if there are two such non-trackable rings residing in the optical disc area for the file (at, e.g., some random radii from the center of the optical disc), the program may require that valid data between the rings be read in order to allow a user to have access to additional data on the optical disc. Thus, if an illicit copy of the optical disc is made, and the file happens to exist, the data therein will be in different relative locations since the non-trackable rings are not present.

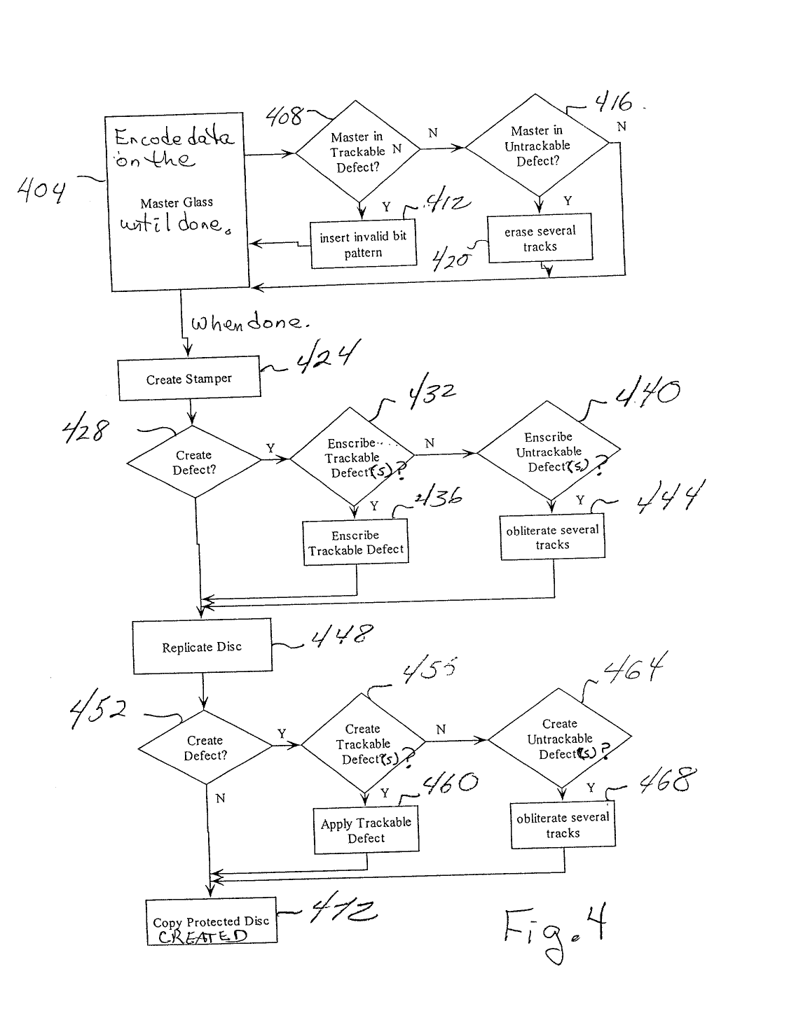

The above discussed methods for purposely creating trackable and untrackable error instances may be combined and implemented within the context of any of the four manufacturing techniques discussed hereinabove. In one exemplary embodiment of such a hybrid technique for copy protection, both the non-trackable rings and the identifier encoded in the trackable error instances may be provided on an optical disc together with a corresponding authentication program(s). For example, FIG. 4 is a flowchart illustrating the various combinations of places where errors can be purposefully embedded when manufacturing of a copy protected optical disc. In particular, an operator or another program, P, may provide input for indicating the path to be taken when exiting each of the decision steps 408, 416, 428, 432, 440, 452, 456 and 464. Thus, during creation of a master glass disc (step 404), at least one of the steps 408 and 416 may be performed: periodically, randomly, at specified locations on the master disc, and/or at specified locations within the data stream being encoded onto the master disc depending on the input provided by an operator or the program P. Thus, purposely positioned non-trackable error instances maybe interleaved with trackable error instances (within a common file or otherwise) for thereby creating a noncopyable sequence or encoding of error instances that can be used to identify the optical disc as authentic.

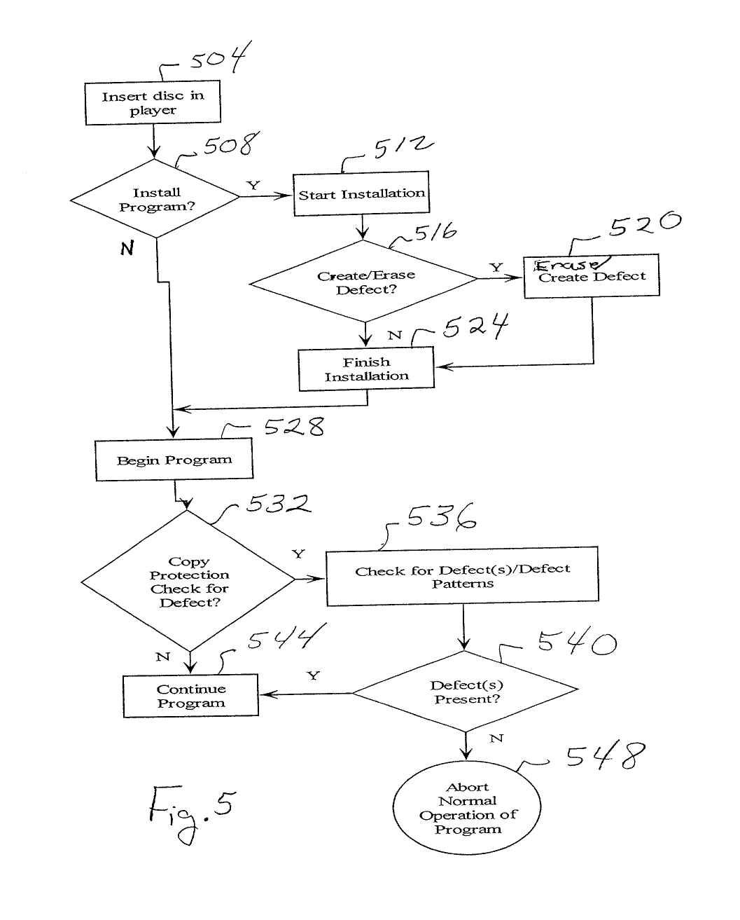

FIG. 5 shows a high level flowchart of the steps performed during an attempt to use an optical disc copy protected according to the present invention. In step 504, such an optical disc is inserted into an optical disk player. In step 508, a determination is made by the user as to whether, e.g., a program or other information residing on the optical disc is to be installed on the user's computational device attached to the optical reader. Assuming installation of the program (and/or the data stored on the optical disc) is desired, step 516 is encountered wherein a determination is made as to whether an action must be performed (by the user or otherwise) that results in the creation and/or the erasure of an error on the optical disc. Thus, the user may be required to generate an error on the optical disc that is substantially unique to the user, or, the user may be required to remove a particular error from the optical disc. Regarding error removal, since it is also within the scope of the present invention to remove or optically change a coating or layer of an optical disc from opaque to clear. Thus, an error generated by such a coating or layer can be erased or removed by, e.g., requesting the user to remove the coating (e.g., by peeling it off) or by inputting a identifier which may be subsequently used to irradiate (via the reading laser) a particular opaque portion(s) of the optical disc and thereby removing errors by chemically changing such portions to clear. Note, that this latter technique of removing optical disc errors via irradiation may be particularly advantageous in both authenticating the optical disc and determining a maximal use thereof. For example, such an optical disc may be designed for at most five uses, wherein there are five distinct areas of the optical disc which are opaque such that with each use one of the five areas is irradiated and thereby an error is removed. Thus, if the disc were copied the entire disc is likely to be scanned which would render both the new disc unusable since there would be no errors to be subsequently erased, and the disc from which the copy was made would be rendered unusable since all such errors would also be erased. Moreover, this latter technique of removing errors may be performed automatically without additional user actions the user would not do otherwise.

Thus, assuming a defect is to be created and/or erased, in step 520, a defect is created/erased automatically or by the user performing a predetermined action for purposefully damaging the optical disc. Alternatively, if no such defect is to be created/erased by the user (and/or automatically), step 524 is performed whereby the program is installed on the user's computational system.

Subsequently, in step 528, the program can be activated, wherein the program determines in step 532 whether optical disc defects should be analyzed for determining the authenticity of the optical disc. Assuming such analysis should be performed, step 536 is encountered wherein defects such as those described hereinabove and/or patterns thereof are attempted to be located. Subsequently, in step 540, a determination is made as to whether there are a sufficient number of optical disc defects for satisfying an authenticity condition either known or accessible to the program (e.g., via a communication on the Internet). If so, then step 544 is performed wherein the program continues and thereby allows the copy protected portions of the optical disc to be accessed for use by the user. Alternatively, if insufficient defects and/or patterns thereof are not encountered, then step 548 is encountered wherein the program aborts, and the remaining content of the optical disc is unavailable to the user.

It is important to note that embodiments of the present inventions may also be used with data storage media different from optical discs. In particular, embodiments of the above disclosed methods for assuring that information residing on a data storage medium is legitimately accessible, may be applied to substantially any such storage media wherein there is a corresponding error detection and correction capability whose output is, e.g., programmatically accessible for further analysis, and wherein programs for performing such analysis are available at end user sites. Accordingly, embodiments of the present invention may be used with magnetic disks, or hybrid combinations of magnetic and optical discs, or other data storage media that may be used for the mass distribution of data. Thus, the present invention may be used for copy protecting and/or providing predetermined limited access (e.g., a predetermined number of accesses) to substantially any data, e.g., music, movies, maps, satellite telemetered data, confidential information, military plans or orders, business plans, electronic coupons, educational materials, etc.

The foregoing discussion of the invention has been presented for purposes of illustration and description. Further, the description is not intended to limit the invention to the form disclosed herein. Consequently, variations and modifications commensurate with the above teachings, within the skill and knowledge of the relevant art, are within the scope of the present invention. The embodiments described hereinabove are further intended to explain the best mode presently known of practicing the invention and to enable others skilled in the art to utilize the invention as such, or in other embodiments, and with the various modifications required by the particular application or uses of the invention. It is intended that the appended claims be construed to include alternative embodiments to the extent permitted by the prior art.

What is claimed is:

1. A method for creating physical defects on an optical disc for identifying said optical disc, comprising:
receiving source signals of data to be encoded onto said optical disc;
combining a representation of said source signals with one or more defective codes;
encoding said representation having said defective codes onto said optical disc so that sites of said optical disc having encodings of said defective codes are capable of generating one or more errors when said optical disc is read by an optical reader, wherein said one or more errors are capable of being identified for identifying said optical disc.

2. A method as claimed in claim 1, wherein said step of encoding includes encoding said combination of said representation and said one or more defective codes onto a master disc.

3. A method as claimed in claim 1, wherein said step of combining includes distributing said defective codes within said representation.

4. A method as claimed in claim 1, wherein said step of combining includes replacing one or more portions of said representation with said defective codes.

5. A method, as claimed in claim 1, wherein said defective codes include at least one code for one of: a continuous data pit along an optical disc track, and a continuous data land along an optical disc track.

6. A method, as claimed in claim 1, wherein said defective codes include a code for a defect that is of multi-track width in a radial direction of said optical disc.

7. A method for creating physical defects on an optical disc for identifying said optical disk, comprising:
receiving a source signal of data to be encoded onto said optical disc;
encoding a representation of said source signals onto a master optical disc;
purposefully damaging said master optical disc for providing one or more defective data areas;
transferring data from said master disc to said optical disc, said optical disc including one or more corresponding data areas corresponding to said one or more defective data areas of said master optical disc, wherein when said corresponding data areas are read by an optical reader, one or more errors are generated that are capable of being identified for identifying said optical disc.

8. A method, as claimed in claim 7, wherein said step of purposefully damaging said master optical disc includes etching said defective data areas into said master disc.

9. A method for creating physical defects on an optical disc for use in identifying said optical disc, comprising:
transferring data from a master optical disc to said optical disc;
determining one or more areas of said optical disc having data thereon;
purposefully damaging said one or more areas so that when said areas are read by an optical reader, read errors are generated that are capable of being identified for identifying said optical disc.

10. A method as claimed in claim 9, wherein said step of purposefully damaging said optical disc includes predetermining said one or more areas.

11. A method as claimed in claim 9, wherein said step of determining includes determining a relative position of each of said areas with respect to an identifiable location on said optical disc.

12. A method for creating physical defects on an optical disc for identifying said optical disc, comprising:
receiving a source signal of data to be encoded onto said optical disc;
encoding a representation of said source signals onto a master optical disc;
creating a metal part or a series of metal parts from the master optical disc;
purposefully damaging said metal part for providing one or more defective data areas;
transferring data from said metal part to said optical disc, said optical disc including one or more corresponding data areas corresponding to said one or more defective areas of said master optical disc, wherein said corresponding data areas are read by an optical reader, one or more errors are generated that are capable of being identified for identifying said optical disc.

13. A method, as claimed in claim 12, wherein said step of purposefully damaging said metal part includes etching said defective data areas into said metal part.

14. A method, as claimed in claim 12, wherein said step of purposefully damaging said optical disc includes predetermining one or more areas for purposefully damaging.

15. A method, as claimed in claim 12, wherein said step of purposefully damaging includes locating a particular one of said areas to be damaged by determining a relative position of the particular one area with respect to an identifiable location on said optical disc.

16. An apparatus for creating physical defects on an optical disc, comprising:
means for receiving source signals of data to be encoded onto said optical disc;
means for combining a representation of said source signals with one or more defective codes;
means for encoding said representation having said defective codes onto said optical disc so that sites of said optical disc having encodings of said defective codes are capable of generating one or more errors when said optical disc is read by an optical reader, wherein said one or more errors are capable of being identified for identifying said optical disc.

17. An apparatus for creating physical defects on an optical disc, comprising:
means for receiving a source signal of data to be encoded onto said optical disc;
means for encoding a representation of said source signals onto a master optical disc;
means for purposefully damaging said master optical disc for providing one or more defective data areas;
means for transferring data from said master disc to said optical disc, said optical disc including one or more corresponding data areas corresponding to said one or more defective data areas of said master optical disc, wherein when said corresponding data areas are read by an optical reader, one or more errors are generated that are capable of being identified for identifying said optical disc.

18. An apparatus for creating physical defects on an optical disc, comprising:
means for transferring data from a master optical disc to said optical disc;
means for determining one or more areas of said optical disc having data thereon;
means for purposefully damaging said one or more areas so that when said areas are read by an optical reader, read errors are generated that are capable of being identified for identifying said optical disc.

19. An apparatus for creating physical defects on an optical disc, comprising:
means for receiving a source signal of data to be encoded onto said optical disc;
means for encoding a representation of said source signals onto a master optical disc;
means for creating a metal part or a series of metal parts from the master optical disc;
means for purposefully damaging said metal part for providing one or more defective data areas;
means for transferring data from said metal part to said optical disc, said optical disc including one or more corresponding data areas corresponding to said one or more defective areas of said master optical disc, wherein said corresponding data areas are read by an optical reader, one or more errors are generated that are capable of being identified for identifying said optical disc.
